(19) United States
(12) Patent Application Publication
(10) Pub. No.: US 2006/0034750 A1
(43) Pub. Date: Feb. 16, 2006

(54) Chlorine dioxide generator and associated methods

(75) Inventors: Sunggyu Lee, Columbia, MO (US); H. Bryan Lanterman, Columbia, MO (US)

Correspondence Address: JACQUELINE E. HARTT, PH.D;ALLEN, DYER, DOPPELT, MILBRATH & GILCHRIST, P.A., P.O. BOX 3791, ORLANDO, FL, 32802-3791, US

(73) Assignee: Water Technologies Limited

(21) Appl. No.: 10/915,766

(22) Filed: Aug. 11, 2004

(51) Int. Cl. C01B 11/02; B01J 8/02

(52) U.S. Cl. 423/477; 422/198; 422/211; 422/144

(57) ABSTRACT

An apparatus and method for producing chlorine dioxide includes a reactor for reacting an aqueous reaction solution including an aqueous acid solution and a solution of an alkali metal salt of a chlorite ion to form a product solution. The reactor includes a substantially cylindrical inner column for receiving the aqueous reaction solution and a substantially cylindrical outer column positioned in coaxial surrounding relation to at least a portion of the inner column. The outer column is for containing a temperature-controlled fluid for maintaining solution flowing through the inner column at a predetermined temperature. A stripper is in fluid communication with an outlet of the inner column for stripping chlorine dioxide from the product solution into a gas to provide a product gas and a stripped product solution. An absorber is provided for absorbing chlorine dioxide from the product gas to provide a substantially byproduct-free aqueous chlorine dioxide solution.

### BACKGROUND OF THE INVENTION

1. Field of the Invention

The present invention relates to generators for chlorine dioxide, and, more particularly, to a chlorine dioxide generator that is modular and scalable.

2. Description of Related Art

Chlorine dioxide is a strong oxidant that has been receiving increased attention as an alternative to chlorine for the disinfection and taste/odor (T/O) control of water and wastewater. The molecular formula of chlorine dioxide is expressed as CO₂. As implied from its chemical formula, it has the disinfecting properties of both chlorine and oxygen. Moreover, chlorine dioxide exhibits good disinfection performance without the disadvantages of forming large quantities of undesirable chlorinated byproducts, since it does not react with hydrocarbons to form chlorinated hydrocarbons.

Chlorine dioxide (CIO₂) first was discovered in 1811 in the form of a greenish-yellow gas by Sir Humphrey Davy, by reacting potassium chlorate (KClO₃) with hydrochloric acid (HCl). It later was found that ClO₂ could be used in a dilute acetic acid (CH₃COOH) solution for the bleaching of paper pulp. Even though the outstanding disinfecting properties of chlorine dioxide have been consistently noted, its practical application has been hampered due to the lack of a safe and economical way of synthesizing it. In the 1930s, the Mathieson Alkali Works developed the first commercial process for making ClO₂, from sodium chlorate (NaClO₃) via sodium chlorite (NaClO₂).

In the 1990s, the U.S. Environmental Protection Agency recommended that, as a part of the reauthorization of the Clean Water Act, a study should be undertaken to develop a strategy to prohibit, reduce, or find substitutes for the use of chlorine and chlorinated compounds. In recent years, free chlorine (Cl₂) has been criticized by environmentalists, even though it is one of the most heavily used chemicals in various chemical and environmental applications. The disadvantages associated with using free chlorine can be summarized as follows:

(1) Chlorine is quite reactive with various substances, including water, ammonia, and hydrocarbons, having a very strong tendency to chlorinate organic chemicals, including phenols and amines to produce chlorinated organics such as chlorophenols and chloroamines;

(2) Even with water, it reacts to produce hydrochloric acid and hypochlorous acid;

(3) Solubility in water is relatively low, making it difficult to adequately disinfect without affecting the vapor space above;

(4) Chlorine is not effective in taste and odor (T/O) control, due to its low water solubility, pungent odor, and acidic reaction; and

(5) It is produced only as a bulk chemical commodity. A small batch capability does not exist, because on-site generation of chlorine is commercially unattractive, making chlorine unsuitable for wastewater treatment.

For at least these reasons, the replacement of chlorine with other chemicals such as chlorine dioxide has been of interest in recent years.

Chlorine dioxide is known to be an excellent disinfectant as well as a strong oxidizing agent. Its bactericidal, fungicidal, algicidal, bleaching, and deodorizing properties are well documented in the literature. Chlorine dioxide is soluble in water at room temperature (20° C.) to about 2.9 grams ClO₂ per liter of water at 30 mmHg partial pressure of ClO₂, or 8 grams per liter at 80 mmHg partial pressure. ClO₂ is approximately 5 times more soluble in water than chlorine gas (Cl₂). ClO₂ is much more soluble in water than oxygen (O₂) which only has 9.2 mg solubility per liter of water. The presence of chlorine dioxide in water is very easily detected by a color change from yellowish-green to orange-red as the concentration of ClO₂ increases in water. At low temperatures, chlorine dioxide dissolves in water to a substantially greater extent due to lower vapor pressure, e.g., 12 g/L at 60 mmHg of partial pressure and 10° C.

The boiling point (b.p.) of the liquid form ClO₂ is 11° C., and the melting point (m.p.) is −59° C. Gaseous ClO₂ has a density of 2.4 (taking air as 1.0), and its molecular weight is 67.45 g/mol; i.e., it is a heavier gas than air. If chlorine dioxide is leaked into the air, it will tend to stay low, near the ground, and then gradually diffuse into the atmosphere.

Chlorine dioxide (ClO₂) differs from Cl₂ in that ClO₂ does not react with water or ammonia. Also, unlike chlorine, ClO₂ does not produce chlorinated hydrocarbons after reacting with hydrocarbons. In general, ClO₂ is less corrosive to most metallic and nonmetallic substances than chlorine, which is an important advantage.

Conventional chlorine dioxide solutions prepared using methods disclosed in the prior art suffer from the drawback that they produce undesirable by-products. Some prior art methods, for example, use either strong acids, which are environmentally unfriendly, or chlorine gas, leading to the formation of a variety of chlorine-containing by-products via complex reaction pathways. Further, known methods are also believed to produce low concentrations of chlorine dioxide.

Thus there has existed a need to provide an economic and efficient method and apparatus for producing chlorine dioxide that does not also produce hazardous by-products (e.g., chlorine or chlorous acid), as well as substantial amounts of unusable salts (e.g., sodium chloride, sodium lactate). There has also existed a need for a method and apparatus for producing chlorine dioxide that does not suffer from the aforementioned disadvantages.

These needs have been solved by the apparatus and method of commonly owned U.S. Pat. Nos. 5,855,861 and 6,051,135, the contents of which are incorporated herein by reference. A particular drawback in certain applications of the inventions of these patents, however, resides in space and scalability considerations. Therefore, it would also be desirable to provide a chlorine dioxide generator having a smaller footprint and ease of scalability.

### SUMMARY OF THE INVENTION

The present invention is directed to an apparatus for making chlorine dioxide that is easy to maintain, has a smaller footprint that prior known devices, has increased energy efficiency, and enables greater throughput. In addition, the present invention permits better conversion efficiency of raw materials, reduces process waste, and is less expensive to operate. The apparatus is highly scalable, and is capable of producing 2-1000 gal/h chlorine dioxide at 10,000 ppm. A final product of the apparatus and method comprises an aqueous chlorine dioxide solution that is substantially pure and substantially free of byproducts. All these features are believed to represent significant improvements over the prior art.

The apparatus in one embodiment comprises a reactor for reacting an aqueous reaction solution including an aqueous acid solution and a solution of an alkali metal salt of a chlorite ion to form a product solution. The reactor comprises a substantially cylindrical inner column for receiving the aqueous reaction solution and a substantially cylindrical outer column positioned in coaxial surrounding relation to at least a portion of the inner column. The outer column is for containing a temperature-controlling fluid for maintaining solution flowing through the inner column at a predetermined temperature. Also provided is a means for maintaining the fluid in the outer column at the predetermined temperature.

A stripper is in fluid communication with an outlet of the inner column for stripping chlorine dioxide from the product solution into a gas to provide a product gas and a stripped product solution. An absorber is provided for absorbing chlorine dioxide from the product gas to provide an aqueous chlorine dioxide solution.

Another embodiment of the present invention includes a modularized apparatus wherein the three columns (the reactor, the stripper, and the absorber) are provided in subdivided sections, typically 2, for ease of delivery. Such a portable unit would be appropriate, for example, for providing chlorine dioxide solution for small municipalities, swimming pools, parks, spas, lagoons, food treatment plants, utilities, remote sites, war and disaster areas, and demonstrations. This unit is designed to deliver 2 gal/h at 10,000 ppm, although this is not intended as a limitation.

The invention further includes a method of making chlorine dioxide, which comprises the steps of reacting an aqueous reaction solution comprising an aqueous acid solution and a solution of an alkali metal salt of a chlorite ion to form a product solution within a substantially cylindrical inner column. Solution within the inner column is maintained at a predetermined temperature. Chlorine dioxide is stripped from the product solution into a gas to provide a product gas and a stripped product solution. Chlorine dioxide is then absorbed from the product gas to provide an aqueous chlorine dioxide solution.

A method of disinfecting a target such as water, wastewater, or a surface comprises the steps of producing chlorine dioxide as above, and using the product solution on the target, such as by introducing the solution into a fluid or applying the solution to a surface, for example.

The features that characterize the invention, both as to organization and method of operation, together with further objects and advantages thereof, will be better understood from the following description used in conjunction with the accompanying drawing. It is to be expressly understood that the drawing is for the purpose of illustration and description and is not intended as a definition of the limits of the invention. These and other objects attained, and advantages offered, by the present invention will become more fully apparent as the description that now follows is read in conjunction with the accompanying drawing.

### BRIEF DESCRIPTION OF THE DRAWINGS

FIG. 1 is a schematic diagram of a first embodiment of the present invention having a single stripper and a single absorber.

FIG. 2 is a schematic diagram of a second embodiment of the present invention having a single stripper and a double absorber.

FIG. 3 is a schematic diagram of a third embodiment of the present invention having a double stripper and a double absorber, with recycle from the first stripper.

FIG. 4 is a schematic diagram of a fourth embodiment of the present invention having a double stripper and a double absorber, with recycle from the second stripper.

FIG. 5 is a schematic diagram of a fifth, modularized embodiment of the present invention having a single stripper and a single absorber.

FIG. 6 is a detailed schematic diagram of the reactor column of FIG. 5.

### DETAILED DESCRIPTION OF THE PREFERRED EMBODIMENTS

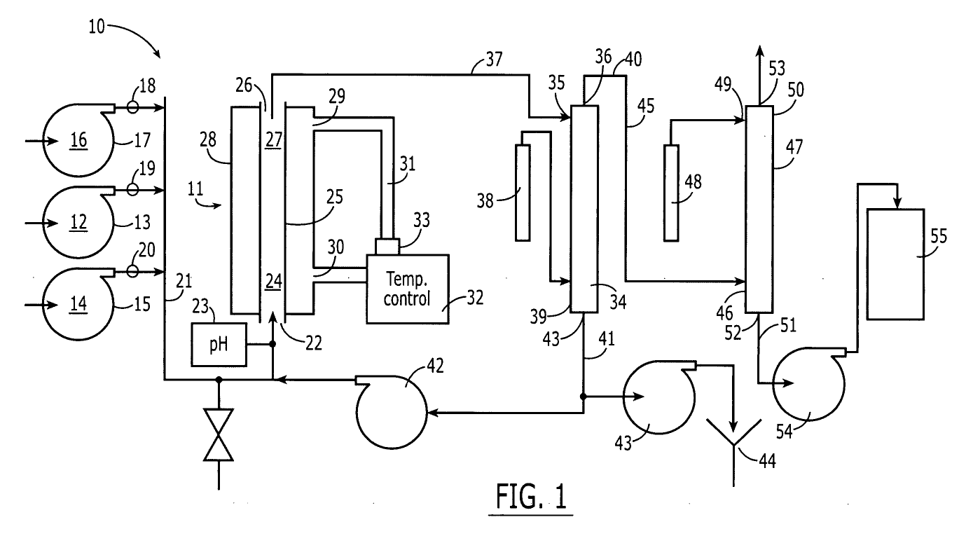

A description of the preferred embodiments of the present invention will now be presented with reference to FIGS. 1-6.

One aspect of the present invention is directed to an apparatus for making chlorine dioxide. A first embodiment of such an apparatus 10, illustrated in FIG. 1, comprises a reactor 11 for reacting an aqueous reaction solution comprising an aqueous acid solution and a solution of an alkali metal salt of a chlorite ion to form a product solution. In a preferred embodiment, the aqueous acid solution comprises an admixed solution 12 of acetic acid and lactic acid, stored in an acid storage tank 13. The alkali metal salt of a chlorite ion preferably comprises sodium chlorite (NaClO₂) 14 stored in a sodium chlorite storage tank 15. Water 16 from water storage tank 17 is also provided.

Each of these tanks 13, 15, 17 is in fluid communication with a respective pump 18, 19, 20 for pumping the tank contents 12, 14, 16 into a line 21 leading to an inlet 22 of the reactor 11. Preferably pH adjustment 23 is also provided downstream of the reactor inlet 22, the pH level preferably ≦4.0. Dilution of the acid 12—sodium chlorite 14 mixture 24 is accomplished by adjusting the amount of water introduced into the line 21.

In a preferred embodiment the reactor 11 comprises a substantially cylindrical inner column 25 having an inlet 22 and an outlet 26. The inner column inlet 22 receives the aqueous reaction solution 24 from line 21, the aqueous reaction solution proceeding upward through the inner column 25, thereby controlling the bubbling of ClO₂. In prior systems that included a coiled passageway, such bubbling can block the flow of liquid, and the reaction mixture can be premixed unnecessarily, which has a deleterious effect on the conversion process. The contents of the aqueous reaction solution 24 react to form a product solution 27 containing chlorine dioxide by the time the reactants reach the inner column outlet 26.

A substantially cylindrical outer column 28 having an inlet 29 and an outlet 30 is positioned in coaxial surrounding relation to at least a portion of the inner column 25. The outer column 28 is for containing a temperature-controlling fluid 31 for maintaining solution flowing through the inner column 25 at a predetermined temperature. The temperature of the fluid 31 is controlled by a temperature-controlling unit 32 and circulating pump 33 substantially continuously cycling fluid 31 through the outer column 28. In a preferred embodiment, the predetermined temperature is approximately 40° C. The flow of fluid 31 may be parallel or antiparallel to the flow of the aqueous reaction solution 24 and product solution 27 through the inner column 25.

A stripper column 34 having a fluid inlet 35 and a gas outlet 36 is in fluid communication via line 37 with the inner column outlet 26 for stripping chlorine dioxide from the product solution 27 into air flowing in countercurrent fashion, the air provided by air injector 38 at an opposite end 39 of the stripper 34 to provide a product gas 40 and a stripped product solution 41.

As the stripped product solution 41 typically will contain some unreacted elements, a recycle pump 42 is provided at the stripper's fluid outlet 43 for returning such elements to the reactor's inlet 22. Alternatively, the stripped product solution 41 may be pumped 43 to a drain 44. If the recycling option is taken, the pH of the mixture rises faster than in the case wherein only fresh reactant is used. Thus the final product concentration that is achievable is lower, but the pH is still maintained, since the fresh reaction feed typically has a pH of approximately 2.7-2.9, while the product pH is around 4.0.

The product gas 40 is then channeled via line 45 to a gas inlet 46 of an absorber column 47. The absorber 47 is in fluid communication with a water injector 48 injecting water at a fluid inlet 49 adjacent an opposite end 50 from the gas inlet 46 to achieve countercurrent flow against flow of the product gas 40. It is preferred that the time during which the CO₂-rich remains a gas be minimized in order to prevent decomposition. The absorber 47 is adapted to absorb chlorine dioxide from the product gas 40 to provide an aqueous chlorine dioxide solution 51 at the absorber fluid outlet 52. Scrubbed air is vented from gas outlet 53 adjacent the absorber fluid inlet 49.

In this and other embodiments the stripper and absorber columns are preferably packed with packing materials such as, but not intended to be limited to, ceramic saddles/rings, glass beads, zirconia beads, etc. Unpacked columns may also be used.

The aqueous chlorine dioxide solution 51 is pumped 54 from the absorber fluid outlet 52 to a storage tank 55, from which it may be dispensed to disinfect a target as discussed above.

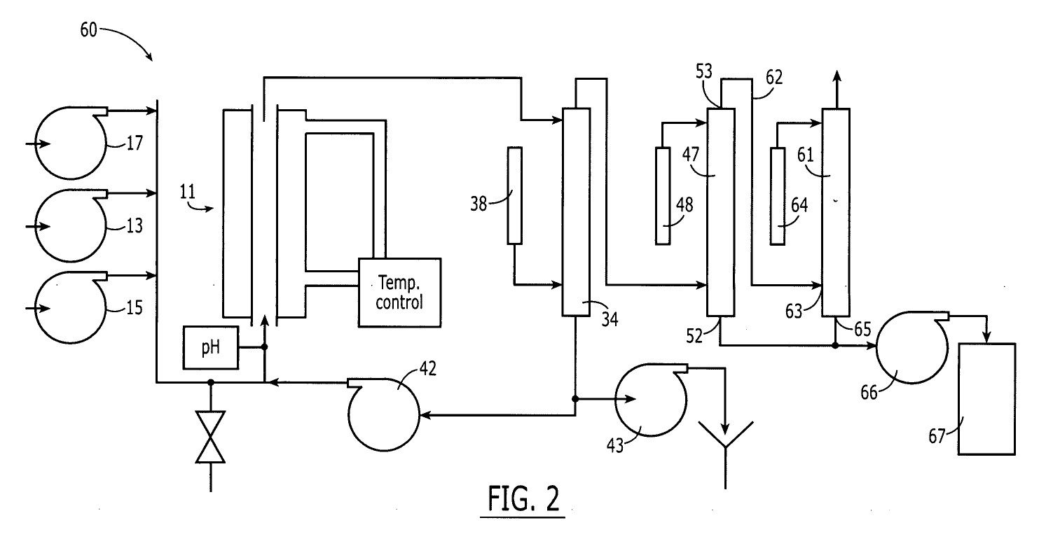

In a second embodiment 60, illustrated in FIG. 2, a second absorber 61 is provided in parallel with the first absorber 47, wherein, instead of venting scrubbed air from the first absorber's gas outlet 53, the scrubbed air is channeled via line 62 to a gas inlet 63 of the second absorber 61. The gas is then contacted with water 64 in countercurrent fashion as previously to yield additional aqueous chlorine dioxide at fluid outlet 65. Liquid emerging from both fluid outlets 52, 65 is then pumped 66 to a product storage tank 67.

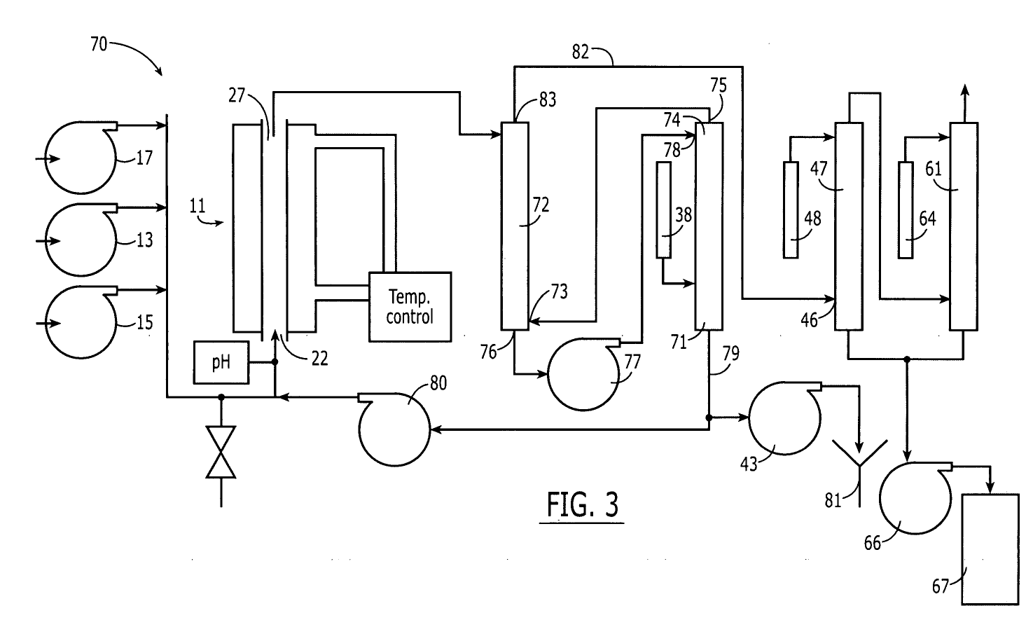

In a third embodiment 70 illustrated in FIG. 3, a second stripper 71 is added between the first stripper 72 and the first absorber 47. In this embodiment, rather than air being injected at a gas inlet 73 of the first stripper 72, the product gas 74 emerging from the second stripper's gas outlet 75 is injected in countercurrent flow to the product solution 27 from the reactor 11, and the first stripped product solution 75 from the first stripper's fluid outlet 76 is pumped 77 to the second stripper's fluid inlet 78. The second stripped product solution 79 is then recycled via pump 80 to the inner column inlet 22 or to drain 81. The product gas 82 emerging from the first stripper's gas outlet 83 is channeled to the first absorber's gas inlet 46.

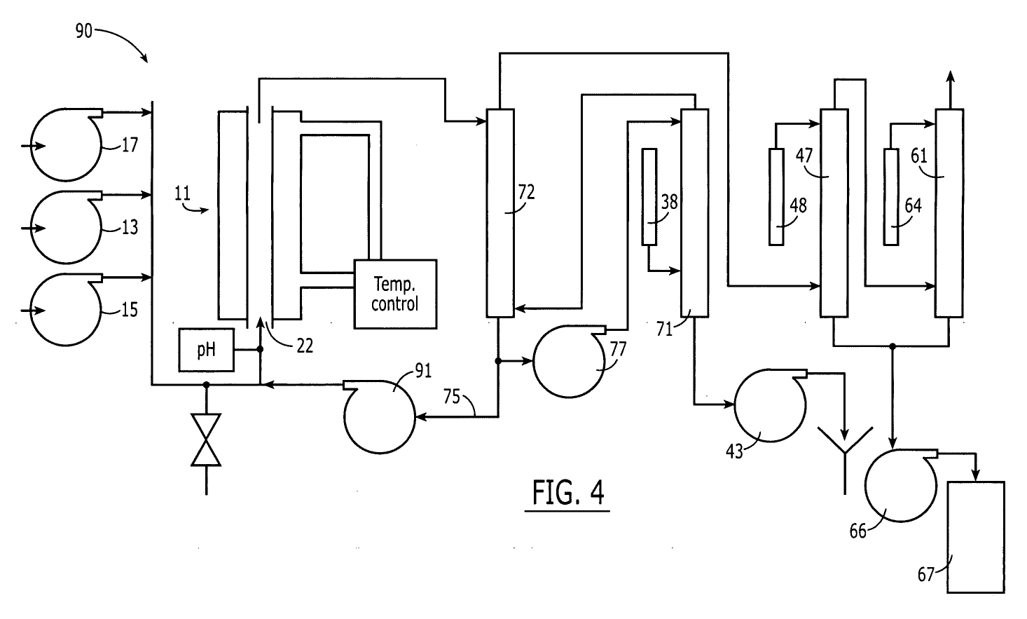

In a fourth embodiment 90, illustrated in FIG. 4, which is similar to that 80 of FIG. 3, it is the first stripped product solution 75 is recycled via pump 91 to the reactor's inlet 22.

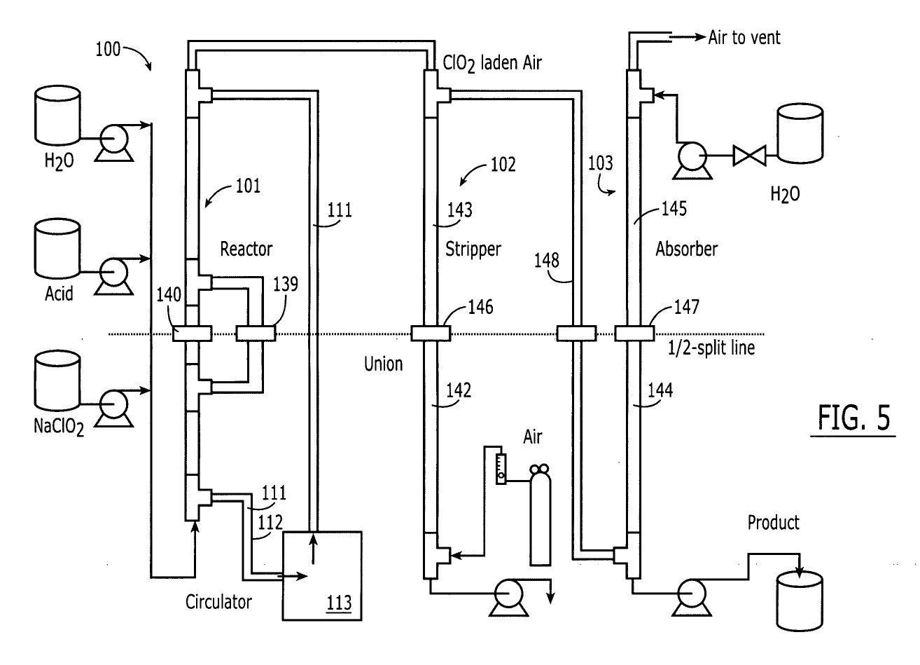

A fifth embodiment, illustrated in FIG. 5, comprises a portable and modularized apparatus 100 for making chlorine dioxide. In this embodiment 100, the three columns 101, 102, 103, operating substantially in the same fashion as described above, are provided as subdivided units for ease of transport.

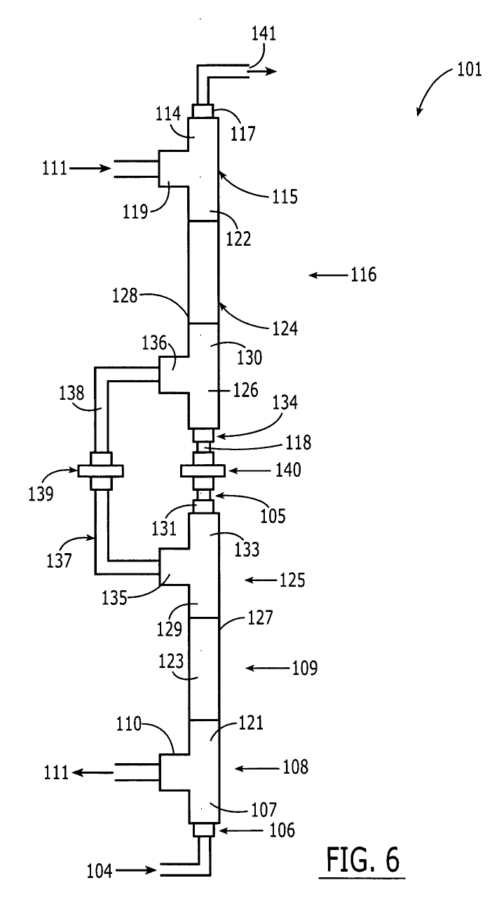

The reactor 101, illustrated in more detail in FIG. 6, has a reactor inlet 104 leading to the inner column 105. A first adapter 106 links the bottom of the first inner column 105 to the bottom arm 107 of a first tee 108, which forms the closed bottom of the first outer column 109. The side arm 110 of the first tee 108 forms an outlet for exiting temperature-controlling fluid 111, and is joined to a line 112 to the circulator/temperature controller 113.

A top arm 114 of a second tee 115 similarly forms the closed top of the second outer column 116 via second adapter 117 linking to the top of the second inner column 118. The side arm 119 of the second tee 115 forms an inlet for temperature-controlling fluid 111 entering the second outer column 116 from the controller 113.

The top arm 121 of the first tee 108 and the bottom arm 122 of the second tee 115 connect, respectively, to first and second jacketing pipes 123, 124, which form the inner sectors of the first and second outer columns 109, 116.

A third 125 and a fourth 126 tee are provided at the top 127 and bottom 128 ends, respectively, of the first and second pipes 123, 124, connected thereto at their bottom 129 and top 130 arms, respectively. Adapters 131, 132 at the third tee's top arm 133 and the fourth tee's bottom arm 134 link to and close the junction with the first 105 and second 118 inner columns, respectively. Their side arms 135,136 provide a path via first and second tubing 137, 138 for bypassing a junction between the inner columns 105, 118 and are joined at a bypass junction 139 to permit temperature-controlling fluid flow.

The first and the second inner columns 105,118 are joined at a junction 140, the first inner column's bottom end serving as the reactor inlet 104, the second column's top end serving as the reactor outlet 141.

In a particular embodiment the tees comprise 1.5-in. tees; the jackets comprise 1.5-in. PVC Sch 40 tubing; and the adapters comprise ¾×1.5-in. adapters, although these specifications are not intended as limitations. Other possible polymeric tubings may include PVDF, CPVC, TTE-lined polyethylene, etc., although these are not intended as limitations.

This apparatus 100 further includes a first and a second stripper 142, 143 positioned collinearly to form the stripper 102 and a first and a second absorber 144, 145 positioned collinearly to form the absorber 103, these being joined at junctions 146, 147.

ClO₂-laden air is channeled via line 148 from the stripper 102 to the absorber 103. Preferably, the ClO₂-laden air should not remain in a gaseous state for very long.

This embodiment 100 is compact and easily transportable, having in a particular embodiment a footprint of only 5×3 ft.

It may be appreciated by one skilled in the art that additional embodiments may be contemplated, including additional modules among any or all of the columns, connected in series or in parallel.

In the foregoing description, certain terms have been used for brevity, clarity, and understanding, but no unnecessary limitations are to be implied therefrom beyond the requirements of the prior art, because such words are used for description purposes herein and are intended to be broadly construed. Moreover, the embodiments of the composition and associated methods described herein are by way of example, and the scope of the invention is not limited to the exact details disclosed.

What is claimed is:

1. An apparatus for making chlorine dioxide comprising:
a reactor for reacting an aqueous reaction solution comprising an aqueous acid solution and a solution of an alkali metal salt of a chlorite ion to form a product solution, the reactor comprising a substantially cylindrical inner column for receiving the aqueous reaction solution and a substantially cylindrical outer column positioned in coaxial surrounding relation to at least a portion of the inner column, the outer column for containing a temperature-controlling fluid for maintaining solution flowing through the inner column at a predetermined temperature;
means for maintaining the fluid in the outer column at the predetermined temperature;
a stripper in fluid communication with an outlet of the inner column for stripping chlorine dioxide from the product solution into a gas to provide a product gas and a stripped product solution; and
an absorber for absorbing chlorine dioxide from the product gas to provide an aqueous chlorine dioxide solution.

2. The apparatus recited in claim 1, wherein the inner and the outer column each has an inlet and the outer column has an outlet, the inlets and outlets of the inner and the outer column positioned for one of substantially parallel and antiparallel flow of aqueous reaction solution and the temperature-controlling fluid.

3. The apparatus recited in claim 1, further comprising means for recycling the stripped product solution to an inlet of the inner column.

4. The apparatus recited in claim 1, wherein the absorber comprises a first and a second absorber positioned in series, an outlet gas from the first absorber transmittable to an inlet of the second absorber, aqueous chlorine dioxide thereby produced by the first and the second absorber.

5. The apparatus recited in claim 4, wherein the stripper comprises a first and a second stripper positioned in series, stripped product solution from the first stripper transmittable to an inlet of the second stripper, product gas from the second stripper transmittable to an inlet of the first stripper, product gas from the first stripper transmittable to an inlet of the first absorber.

6. The apparatus recited in claim 5, further comprising means for recycling stripped product solution from the first stripper to an inlet of the inner column.

7. The apparatus recited in claim 5, further comprising means for recycling stripped product solution from the second stripper to an inlet of the inner column.

8. The apparatus recited in claim 1, wherein at least one of the stripper and the absorber comprises a column packed with a packing material.

9. The apparatus recited in claim 8, wherein the packing material is selected from a group consisting of ceramic saddle/rings, glass beads, and zirconia beads.

10. A portable and modularized apparatus for making chlorine dioxide comprising:
a reactor for reacting an aqueous reaction solution comprising an aqueous acid solution and a solution of an alkali metal salt of a chlorite ion to form a product solution, the reactor comprising a first and a second substantially cylindrical inner column connectable in series, the first inner column having an inlet for receiving the aqueous reaction solution, a first and a second substantially cylindrical outer column connectable in series, the first and the second outer columns positioned in coaxial surrounding relation to at least a portion of the first and the second inner column, respectively, the first and the second outer column for containing a temperature-controlling fluid for maintaining aqueous reaction solution flowing through the first and the second inner column at a predetermined temperature;
means for maintaining the fluid in the first and the second outer column at the predetermined temperature;
a first and a second stripper positionable in series, the first stripper in fluid communication with an outlet of the second inner column, the first and the second stripper for stripping chlorine dioxide from the product solution into a gas to provide a product gas and a stripped product solution at an outlet of the second stripper; and
a first and a second absorber positionable in series, the first absorber in fluid communication with the second stripper outlet for absorbing chlorine dioxide from the product gas to provide an aqueous chlorine dioxide solution at an outlet of the second absorber.

11. The apparatus recited in claim 10, wherein the first outer column has an outlet and the second outer column has an inlet, the inlets of the first inner column and the second outer column, and the outlets of the second inner and the first outer column positioned for substantially antiparallel flow of aqueous reaction solution and the temperature-controlling fluid.

12. The apparatus recited in claim 10, wherein the first and the second inner columns, the first and the second strippers, and the first and the second absorbers are positionable in substantially collinear fashion, an outlet of the first inner column connectable to an inlet of the second inner column, an outlet of the first stripper connectable to an inlet of the second stripper, an outlet of the first absorber connectable to an inlet of the second absorber.

13. The apparatus recited in claim 10, further comprising couplers affixed to the first inner column outlet, the second inner column inlet, the first stripper outlet, the second stripper inlet, the first absorber outlet, and the second absorber inlet, the couplers for providing connectability.

14. The apparatus recited in claim 13, wherein an outlet of the first outer column is connectable to an inlet of the second outer column.

15. The apparatus recited in claim 14, further comprising a bypass tubing for connecting the first outer column outlet with the second outer column inlet, the bypass tubing positioned to bypass the couplers connecting the first inner column outlet with the second inner column inlet.

16. A method for producing chlorine dioxide comprising the steps of:
reacting an aqueous reaction solution comprising an aqueous acid solution and a solution of an alkali metal salt of a chlorite ion to form a product solution within a substantially cylindrical inner column;
maintaining solution within the inner column at a predetermined temperature;
stripping chlorine dioxide from the product solution into a gas to provide a product gas and a stripped product solution; and
absorbing chlorine dioxide from the product gas to provide an aqueous chlorine dioxide solution.

17. The method recited in claim 16, wherein the temperature-maintaining step comprises flowing a temperature-controlling fluid through an outer column positioned in coaxial surrounding relation to at least a portion of the inner column.

18. The method recited in claim 16, further comprising recycling the stripped product solution to an inlet of the inner column.

19. The method recited in claim 16, wherein the absorbing step is performed by a first and a second absorber positioned in series, the absorbing step comprising transmitting an outlet gas from the first absorber to an inlet of the second absorber, aqueous chlorine dioxide thereby produced by the first and the second absorber.

20. The method recited in claim 19, wherein the stripping step is performed by a first and a second stripper positioned in series, the stripping step comprising transmitting stripped product solution from the first stripper to an inlet of the second stripper, transmitting product gas from the second stripper to an inlet of the first stripper, and transmitting product gas from the first stripper to an inlet of the first absorber.

21. The method recited in claim 20, further comprising the step of recycling stripped product solution from the first stripper to an inlet of the inner column.

22. The method recited in claim 20, further comprising the step of recycling stripped product solution from the second stripper to an inlet of the inner column.

23. A method for making chlorine dioxide comprising the steps of:
reacting an aqueous reaction solution comprising an aqueous acid solution and a solution of an alkali metal salt of a chlorite ion to form a product solution using a first and a second substantially cylindrical inner column connectable in series, the first inner column having an inlet for receiving the aqueous reaction solution;
maintaining solution in the first and the second inner column at a predetermined temperature;
stripping chlorine dioxide from the product solution into a gas to provide a product gas and a stripped product solution by positioning a first and a second stripper in series, the first stripper in fluid communication with an outlet of the second inner column; and
absorbing chlorine dioxide from the product gas to provide an aqueous chlorine dioxide solution by positioning a first and a second absorber in series, the first absorber having an inlet in fluid communication with an outlet of the second stripper for receiving the product gas, aqueous chlorine dioxide solution emerging from an outlet of the second absorber.

24. The method recited in claim 23, wherein the temperature-maintaining step comprises flowing a temperature-controlling fluid through a first and a second substantially cylindrical outer column connectable in series, the first and the second outer columns positioned in coaxial surrounding relation to at least a portion of the first and the second inner column, respectively, the first and the second outer column for containing a temperature-controlling fluid.

25. The method recited in claim 24, wherein solution flow through the first and the second inner column and fluid flow through the first and the second outer column is substantially antiparallel.

26. A method of disinfecting a target comprising the steps of:
reacting an aqueous reaction solution comprising an aqueous acid solution and a solution of an alkali metal salt of a chlorite ion to form a product solution within a substantially cylindrical inner column;
maintaining solution within the inner column at a predetermined temperature;
stripping chlorine dioxide from the product solution into a gas to provide a product gas and a stripped product solution;
absorbing chlorine dioxide from the product gas to provide an aqueous chlorine dioxide solution; and
using the aqueous chlorine dioxide solution to disinfect the target.

27. The method recited in claim 26, wherein the target comprises a liquid, and the aqueous chlorine dioxide solution using step comprises introducing the aqueous chlorine dioxide solution into the liquid.

28. The method recited in claim 26, wherein the target comprises an object, and the aqueous chlorine dioxide solution using step comprises applying the aqueous chlorine dioxide to the object.
